(19) United States
(12) Patent Application Publication
(10) Pub. No.: US 2018/0056908 A1
(43) Pub. Date: Mar. 1, 2018

(54) RETRACTABLE PROTECTIVE BUMPER SYSTEM

(71) Applicant: Antoine Sayour, Brooklyn, NY (US)

(72) Inventor: Antoine Sayour, Brooklyn, NY (US)

(21) Appl. No.: 15/691,326

(22) Filed: Aug. 30, 2017

Related U.S. Application Data
(60) Provisional application No. 62/381,431, filed on Aug. 30, 2016.

(51) Int. Cl. B60R 19/38; B60R 19/02

(52) U.S. Cl. CPC B60R 19/38; B60R 19/023

(57) ABSTRACT

A retractable bumper system including a bumper having an exterior surface and at least one retracting member moveable between a first position and second position, wherein in the first position, an outer surface of the at least one retracting member is flush with the exterior surface of the bumper and in the second position the at least one retracting member extends beyond the exterior surface of the bumper.

### CROSS-REFERENCE TO PRIOR APPLICATIONS

This application claims priority to U.S. Provisional Application Ser. No. 62/381,431 filed on Aug. 30, 2016. The application is hereby incorporated by reference herein in its entirety.

### FIELD

Embodiments of the present invention generally relate to a retractable protection device that is user controlled and/or automatically operable and allows a user to protect and minimize damage to the front and/or rear bumpers of a vehicle.

### BACKGROUND

Bumpers of vehicles can be expensive to replace when damaged. Various devices are disclosed in the prior art which are used to protect bumpers of vehicles from impact with other vehicles, especially when other vehicles are parking in front or in back of the subject vehicle. Such devices are typically protective guards for the bumper, some of which cover almost the entirety of the bumper, are aesthetically displeasing and require a user to manually affix and remove them.

### SUMMARY

Embodiments of the present invention can provide a retractable bumper system including a bumper having an exterior surface, and at least one retracting member moveable between a first position and second position, wherein in the first position, an outer surface of the at least one retracting member is flush with the exterior surface of the bumper and in the second position the at least one retracting member extends beyond the exterior surface of the bumper.

According to certain embodiments, the at least one retracting member extends and retracts from within the bumper. The bumper may include a cover having a hinge biased to pivot the cover into the interior of the bumper.

According to certain embodiments, the at least one retracting member may be smaller in size relative to the bumper.

According to certain embodiments, the at least one retracting member may be coupled to an extension mechanism. The extension mechanism may be coupled to a circuit which may include a switch. The extension mechanism may include a piston.

According to certain embodiments, the outer surface of the at least one retracting member may be replaceable.

According to certain embodiments, the at least one retracting member may be composed out of one material. The at least one retracting member may be composed out of a plurality of materials. Further, a top layer of the least one retracting member may be composed of the same material as the bumper.

Another embodiment of the present invention can provide a method of manufacturing a retractable bumper system comprising placing at least one retracting member into the interior of a bumper such that, when the at least one retracting member is extended, the at least retracting member extends beyond an exterior surface of the bumper.

Another embodiment of the present invention can provide a retractable bumper system including a bumper including an exterior surface, a circuit housed in the bumper, an extension mechanism coupled to the circuit, and at least one retracting member housed in the bumper and coupled to the extension mechanism, wherein the extension mechanism causes the at least one retracting means to extend beyond the exterior surface of the bumper.

Another embodiment of the present invention can provide an automobile comprising a retractable bumper system including a bumper having an exterior surface and at least one retracting member moveable between a first position and second position, wherein in the first position, an outer surface of the at least one retracting member is flush with the exterior surface of the bumper and in the second position the at least one retracting member extends beyond the exterior surface of the bumper.

### BRIEF DESCRIPTION OF THE DRAWINGS

The features and advantages of the present invention can be more readily understood from the following detailed description with reference to the accompanying drawings, wherein:

FIG. 1 is a front view of a car having installed on it one embodiment of the retractable bumper system with extendable and retractable members in a retracted position;

FIG. 2 is a partial perspective view of a car illustrating, according to one embodiment, the retractable bumper system of FIG. 1 after the extendable and retractable members have been extended to an extended position.

FIG. 3 is a partial perspective view of a car illustrating, according to one embodiment, the retractable bumper system of FIG. 1 after the extendable and retractable members have been retracted to a retracted position.

FIG. 4 illustrates circuitry according to an embodiment of the present invention that allows a user to control the retracted or extended position of the extendable and retractable members of the retractable bumper system.

FIG. 5 is a detailed perspective view illustrating, according to one embodiment, the retractable bumper system with the extendable and retractable members in an extended position.

FIG. 6 is a block diagram illustrating, according to one embodiment, the operation of two extendable and retractable members which employ pistons as a mechanism for their extension and retraction.

### DETAILED DESCRIPTION

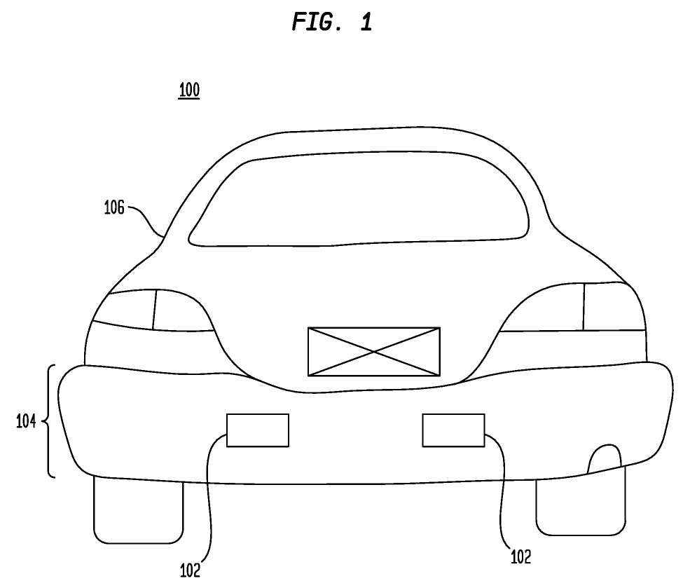

Exemplary embodiments of the present invention can provide a novel retractable bumper system. Exemplary retractable bumper system 100 is shown in FIGS. 1-6. Exemplary retractable bumper system 100 can facilitate the protection of the bumper of an automobile. For example, exemplary retractable bumper system 100 can retract and extend from the bumper of an automobile aiding in the parking, driving, or maneuvering of an automobile.

As shown in FIGS. 1-3, exemplary retractable bumper system 100 may include retracting members 102. Exemplary retractable bumper system 100 may be installed on automobile 106. Automobile 106 may be a car, truck, bus, or any other type of automobile. Exemplary retractable bumper system 100 may include two retracting members 102. However, exemplary retractable bumper system 100 may include any numbers of retracting members, such has one, three, four, five or any other number of retracting members. Retracting members 102 may be installed on bumper 104 of automobile 106. In one embodiment of the present invention, retracting members 102 may be built-in to bumper 104. For example, retracting members 102 may be housed at least partially within bumper 104. In another embodiment of the present invention, retracting members 102 may extend from the exterior surface of bumper 104.

Retracting members 102 may be any shape, size or material and may be positioned at various locations around bumper 104. For example, in one embodiment of the present invention, retracting members 102 may be placed on the left and right side of bumper 104. In another embodiment of the present invention, retracting members 102 may be placed in the center of bumper 104. In one embodiment of the present invention, retracting members 102 may be rubber. However, retracting members 102 may be plastic, metal, alloy, or other material or combination of materials known in the art to effectively absorb impact. Further, retracting members 102 may be solid or hollow or partially hollow.

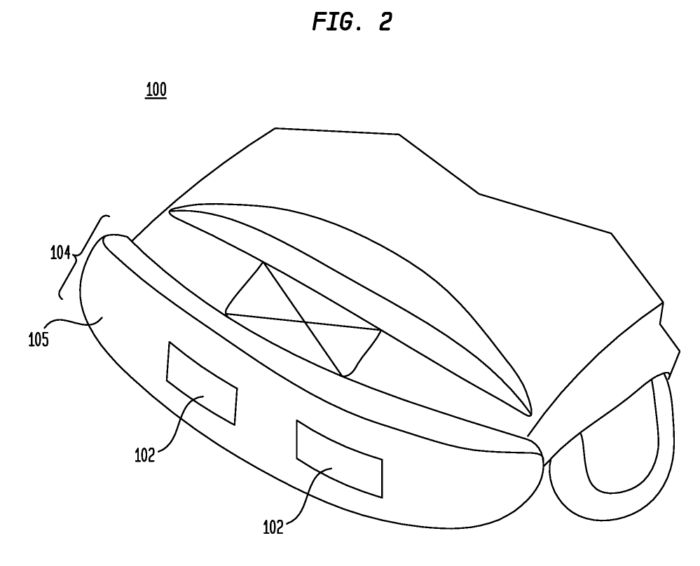

According to one embodiment of the present invention, retracting members 102 may be made out a single material. In another embodiment of the present invention, retracting members 102 may comprise several layers of different materials. For example, the top layer of retracting members 102 may be the same material as bumper 104 of automobile 106. As shown in FIG. 2, retracting members 102 may be retracted into bumper 104 and may appear to blend in with bumper 104 as the top layer of retracting member 102 is the same material as bumper 104. The total size of the retracting members 102 on bumper 104 may be relatively small in comparison to the size of bumper 104, or may be relatively large, taking up a larger portion of bumper 104. For example, retracting members 102 may be rectangular (with or without rounded corners), square (with or without rounded corners), circular, elliptical, or any other shape. In one embodiment of the present invention, retracting members 102 may be replaceable. For example, in the event of damage, or for any other reason, retracting members 102 may be easily individually removed and replaced, without the need to replace the entirety of bumper 104 of automobile 106.

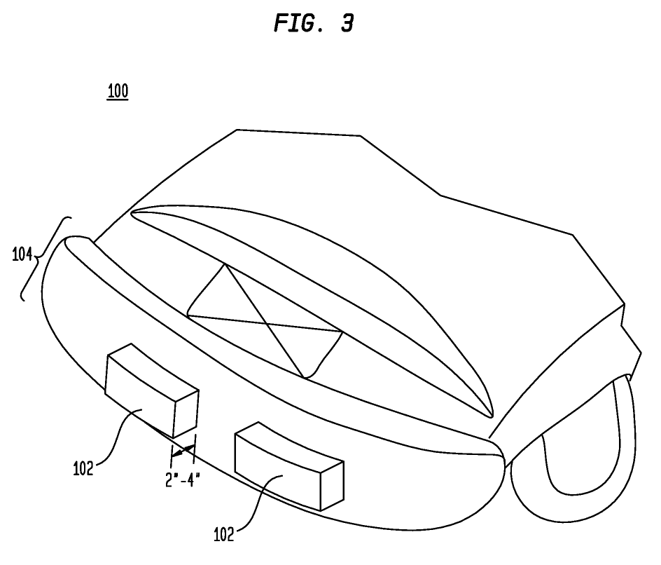

As shown in FIG. 3, retracting members 102 may include outer surface 103. Outer surface 103 may be on the outer most portion of retracting members 102. Outer surface 103 may be the only portion of retracting members 102 that comes into contact with an obstacle. In one embodiment of the present invention, outer surface 103 may be the same material as retracting members 102. In another embodiment of the present invention, outer surface 103 may be a different material than retracting members 102. In yet another embodiment of the present invention, outer surface 103 may be the same material as bumper 104. Outer surface 103 may be removably coupled to retracting members 102. Outer surface 103 being removably coupled to retracting members 102 allows for outer surface 103 to be replaceable when the user wants to replace outer surface 103 such as when it is damaged, scratched, change in color of bumper 104, or any other reason.

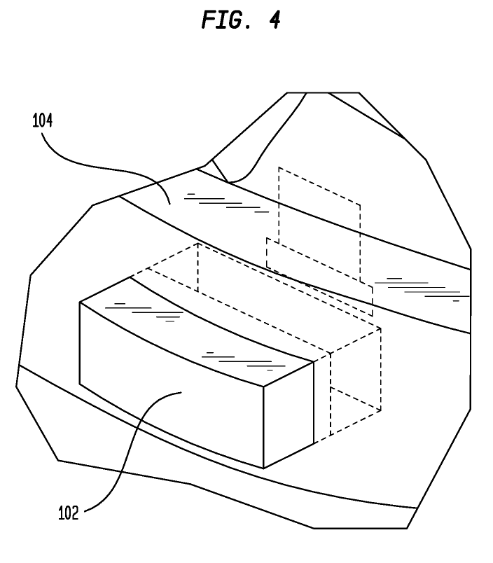

As shown in FIGS. 3 and 4, retracting members 102 may be in an extended position. When retracting members 102 are in an extended position, retracting members 102 may extend from bumper 104. Retracting members 102 may extend from bumper 104 two to four inches. However, retracting member 102 may extend from bumper 104 by any amount such as three inches, four inches, five inches or any other amount. According to certain embodiments of the present invention, there may be space behind bumper 104, into which retracting members 102 may retract or partially retract.

In one embodiment of the present invention, bumper 104 may include a cover for retracting members 102. The cover may be located on the exterior surface of bumper 104 in front of where retracting members 102 may be housed. The cover may include a hinge. The hinge may allow for the cover to be biased to allow for the cover to pivot into the interior of bumper 104 allowing for retracting members 102 to exit bumper 104. In practice, prior to retracting members 102 extending from bumper 104, the cover may pivot into bumper 104 allowing retracting members 102 to extend from bumper 104. Once retracting members 102 have retracted into bumper 104, the cover may pivot back to a resting position where the cover is flush with exterior surface 105 of bumper 104. In another embodiment of the present invention, the cover may slide into the interior of bumper 104 prior to retracting members 102 extending. In this embodiment, once retracting members 102 have retracted into bumper 104, the cover may return to a resting position, where it is flush with exterior surface 105 of bumper 104.

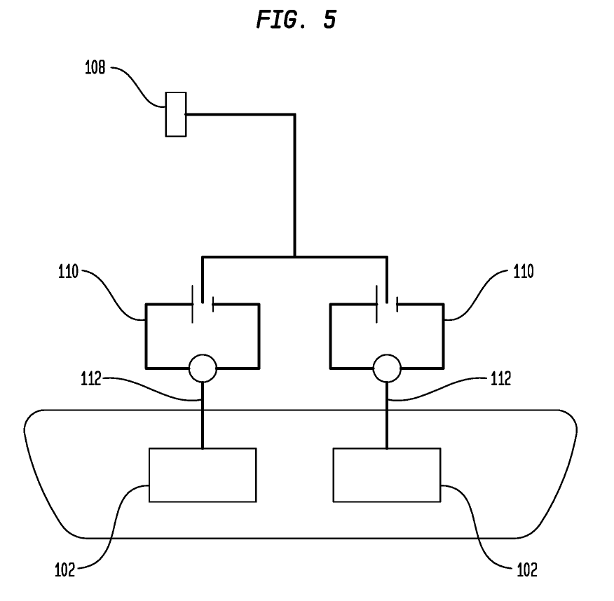

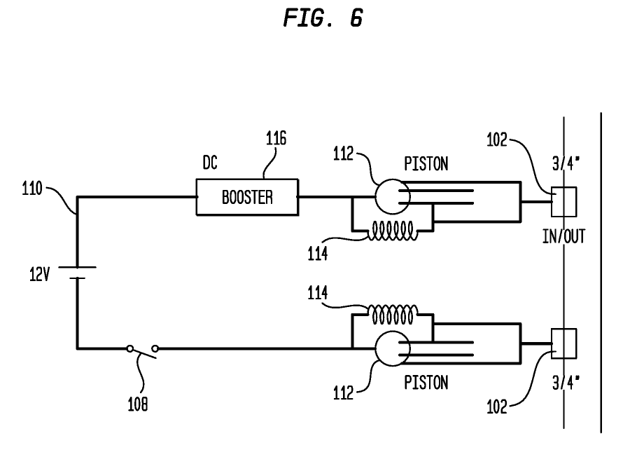

As shown in FIGS. 5 and 6, retracting members 102 may be coupled to extension mechanisms 112, which may be coupled to circuit 110. In certain embodiments, the coupling of retracting members 102 to circuits 110 may also be located behind the bumper. Such connection may be by way of wires or wireless communications, or such methods of sending signals as are known in the art. In practice, extension mechanisms 112 may be coupled to the exterior of retracting members 102. However, extension mechanisms 112 may be coupled to the interior of retracting members 102 or housed within retracting members 102. Extension mechanisms 112 being coupled to retracting members 102 may allow for the extension and retraction of retracting members 102 from bumper 104. In one embodiment of the present invention, extension mechanisms 112 may be a piston. However, extension mechanisms 112 may be a spring, a jack, a gear system, or any other mechanism capable of retracting and extending retracting member 102 from bumper 104. In another embodiment of the present invention, extension and retraction of retracting members 102 from bumper 104 may occur through materials that can adjust the depth of the extendable and retractable member. For example, retracting members 102 may be made of an expandable or elastic material or may telescope, and may be filled with air or other fluid. Other methods of translation and/or elongation as are known in the art may be used to retract and extend retracting members 102.

In one embodiment of the present invention, extension mechanisms 112 may be coupled to circuits 110 and further coupled to retracting members 102. Circuits 110 may allow a user to control the retraction or extension of retracting arms 102 from bumper 104. Circuits 110 may include switch 108 or may be coupled to switch 108. Switch 108 may allow a user to control circuits 110. In practice, a user may activate switch 108 which may power circuits 110 causing extension mechanisms 112 to activate. However, a user may use a remote, button, or any other type of device to activate extension mechanisms 112. Activation of extension mechanisms 112 may extension mechanisms 112 to extend. Extension of extension mechanisms 112 may cause retracting element 102 to extend from bumper 104. It will be understood that such circuitry found in circuits 110 is known in the art and may be employed to actuate extension mechanisms 112. According to one embodiment of the present invention, a user may control exemplary retractable bumper system 100 in a manner that allows the user to select the specific length of extension of retracting members 102 via extension mechanism 112. According to another embodiment of the present invention, motor vehicle 106 and/or switch 108 may be preprogrammed with several different lengths of extension that a user can select. According to yet another embodiment of the present invention, exemplary retractable bumper system 100 may include a sensor that may automatically detect the maximum length of extension of retracting members 102 via extension mechanism 112. In one embodiment of the present invention, circuits 110 may include the sensor. In another embodiment of the present invention, the sensor may be coupled to circuits 110. The sensor may automatically extend retracting members 102 when an obstacle is within a certain distance of retractable bumper system 100. Retracting members 112 may extend without hitting any parked car or other obstacle. The sensor of exemplary retractable bumper system 100 may also determine that no such obstacles are present within a predefined distance. Circuits 110 may be used to automatically (or, upon user engagement) extend the extension mechanism 112 causing retracting members 102 to extend to this determined length, or to a slight amount less than this determined length, or to, in the event that no obstacles are detected, a predetermined and/or user-set maximum extension length. In one embodiment of the present invention, retracting members 102 may extend when the automobile 106 is locked. Further, retracting members 102 may retract into bumper 104 when automobile 106 is unlocked.

As shown in FIG. 6, exemplary circuit 110 may include booster 116. Booster 116 may be used to power and control extensions mechanisms 112. In one embodiment of the present invention, extension mechanisms 112 may include pistons, which may be coupled to booster 116. Exemplary circuit 110 may further include switch 108. In practice, a user may activate switch 108 which may complete circuit 110. Completion of circuit 110 may activate booster 116 which may cause the extension of extension mechanisms 112. Extension of extension mechanisms 112 may cause extension of retracting members 102 from bumper 104. Upon further activation of switch 108, circuit 110 may become open, causing extension mechanisms 112 to retract, thus retracting retracting members 102 into bumper 104.

The embodiments and examples shown above are illustrative, and many variations can be introduced to them without departing from the spirit of the disclosure. For example, elements and/or features of different illustrative and exemplary embodiments herein may be combined with each other and/or substituted with each other within the scope of the disclosure. For a better understanding of the disclosure, reference should be had to any accompanying drawings and descriptive matter in which there is illustrated exemplary embodiments of the present invention.

1. A retractable bumper system comprising:
a bumper including an exterior surface; and
at least one retracting member moveable between a first position and second position, wherein in the first position, an outer surface of the at least one retracting member is flush with the exterior surface of the bumper and in the second position the at least one retracting member extends beyond the exterior surface of the bumper.

2. The retractable bumper system of claim 1, wherein the at least one retracting member extends and retracts from within the bumper.

3. The retractable bumper system of claim 1, wherein the bumper includes a cover having a hinge biased to pivot the cover into the interior of the bumper.

4. The retractable bumper system of claim 1, wherein the at least one retracting member is smaller in size relative to the bumper.

5. The retractable bumper system of claim 1, wherein the at least one retracting member is coupled to an extension mechanism.

6. The retractable bumper system of claim 1, wherein the outer surface of the at least one retracting member is replaceable.

7. The retractable bumper system of claim 4, wherein the extension mechanism is coupled to a circuit which includes a switch.

8. The retractable bumper system of claim 1, wherein the at least one retracting member is composed out of one material.

9. The retractable bumper system of claim 1, wherein the at least one retracting member is composed out of a plurality of materials.

10. The retractable bumper system of claim 1, wherein a top layer of the least one retracting member is composed of the same material as the bumper.

11. The retractable bumper system of claim 4, wherein the extension mechanism includes a piston.

12. A method of manufacturing a retractable bumper system comprising placing at least one retracting member into the interior of a bumper such that, when the at least one retracting member is extended, the at least retracting member extends beyond an exterior surface of the bumper.

13. A retractable bumper system comprising:
a bumper including an exterior surface;
a circuit housed in the bumper;
an extension mechanism coupled to the circuit;
at least one retracting member housed in the bumper and coupled to the extension mechanism, wherein the extension mechanism causes the at least one retracting means to extend beyond the exterior surface of the bumper.

14. An automobile comprising a retractable bumper system including:
a bumper having an exterior surface; and
at least one retracting member moveable between a first position and second position, wherein in the first position, an outer surface of the at least one retracting member is flush with the exterior surface of the bumper and in the second position the at least one retracting member extends beyond the exterior surface of the bumper.
